(19) United States
(12) Patent Application Publication
(10) Pub. No.: US 2011/0262793 A1
(43) Pub. Date: Oct. 27, 2011

(54) MAINTENANCE-FREE THERMAL MANAGEMENT BATTERY PACK SYSTEM

(75) Inventors: Antonio Reis, Modesto, CA (US); Oliver Xie, Lansdale, PA (US)

(73) Assignee: International Battery, Inc., Allentown, PA (US)

(21) Appl. No.: 12/767,241

(22) Filed: Apr. 26, 2010

(51) Int. Cl. H01M 10/50; H01M 10/04

(52) U.S. Cl. 429/120; 29/623.1

(57) ABSTRACT

A thermal management battery pack system includes a containment box having a plurality of sides located around a perimeter of the bottom and a hermetically sealed cell box containing at least one energy cell located within the cell box. The cell box has a cover and a plurality of sides. The sides of the cell box are located away from the sides of the containment box. A plurality of external power connection points are located on the cover of the cell box. A dielectric fluid fills the cell box around the at least one energy cell. A sufficient amount of a phase-change material is located in the dielectric fluid to maintain a temperature within the cell box to within about five degrees Celsius of a temperature exterior to the containment box.

### FIELD OF INVENTION

The present invention relates to a battery pack system that includes a passive thermal management system.

### BACKGROUND

Battery pack systems may be used to receive and store energy generated by an outside source for later use. These systems may be located in an outdoor environment and are subject to temperature fluctuations, ranging from extreme heat to extreme cold. Prior art systems use fans to generate air flow around the batteries in the system to transfer excess heat away from the batteries. These fans, however, require electrical energy to operate and may be subject to failure, which may result in an undesired overheating of the system. Accordingly, there is a need for a system that uses a passive heat transfer system to dissipate excess heat away from the batteries.

### SUMMARY OF THE INVENTION

Briefly, the present invention provides a thermal management battery pack system comprising a containment box having a plurality of sides located around a perimeter of the bottom and a hermetically sealed cell box containing at least one energy cell located within the cell box. The cell box has a cover and a plurality of sides. The sides of the cell box are located away from the sides of the containment box. A plurality of external power connection points are located on the cover of the cell box. A dielectric fluid fills the cell box around the at least one energy cell. A sufficient amount of a phase-change material is located in the dielectric fluid to maintain a temperature within the cell box to within about five degrees Celsius of a temperature exterior to the containment box.

The present invention further provides a thermal management battery pack system comprising a cell box, a plurality of energy cells located within the cell box, and a thermal management system comprising a phase-change material located in the cell box and a dielectric fluid covering the plurality of energy cells and the phase-change material, wherein an adequate type and amount of phase-change material is located in the cell box to maintain a temperature of the cell box within about twenty degrees Celsius of a temperature outside of the cell box.

A method of manufacturing a battery pack system comprises the steps of placing at least one energy cell in a cell box; placing a phase-change material in the cell box; covering the at least one energy cell and the phase-change material in a dielectric fluid; placing a cover over the cell box; and placing the cell box in a containment box having a plurality of side walls, forming a space between the cell box and the side walls of the containment box.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings certain embodiments of the present invention. It should be understood, however, that the invention is not limited to the precise arrangements and instrumentalities shown. In the drawings, the same reference numerals are employed for designating the same elements throughout the several figures. In the drawings:

FIG. 1 is a perspective view of an energy cell box of a thermal management battery pack system, with its cover removed, according to an exemplary embodiment of the present invention;

FIG. 2 is a perspective view of the energy cell box of FIG. 1, with its cover in place;

FIG. 3 is a schematic drawing of the thermal management battery pack system of FIG. 1 coupled to a plurality of houses and to a control hub;

FIG. 4 is a sectional view of the thermal management battery pack system according to an exemplary embodiment of the present invention;

FIG. 5 is a perspective view of the thermal management battery pack system of FIG. 4;

FIG. 6 is an exemplary electrical schematic of the thermal management battery pack system of FIG. 4;

FIG. 7 is a perspective view of the thermal management battery pack system of FIG. 4;

FIG. 8 is a flowchart illustrating steps performed in the manufacture of the maintenance-free thermal management battery pack system of FIG. 4;

FIG. 9 is a side elevational view of a thermal management battery pack system according to an alternative embodiment of the present invention; and

FIG. 10 is a perspective view of the thermal management battery pack system illustrated in FIG. 9.

### DETAILED DESCRIPTION OF THE PRESENT INVENTION

In describing the embodiments of the invention illustrated in the drawings, specific terminology will be used for the sake of clarity. However, the invention is not intended to be limited to the specific terms so selected, it being understood that each specific term includes all technical equivalents operating in similar manner to accomplish similar purpose. It is understood that the drawings are not drawn exactly to scale. In the drawings, similar reference numbers are used for designating similar elements throughout the several figures.

The following describes particular embodiments of the present invention. It should be understood, however, that the invention is not limited to the embodiments detailed herein. As used herein, two devices are “electrically coupled” when electricity is able to pass between the two devices. Also, as used herein, a “hermetically sealed” device is sealed to prevent the passage of fluids into or out of the device.

Referring now to the figures in general, an exemplary embodiment of the present invention includes a thermal management battery pack system 100 comprising at least one energy cell 101, and typically, a plurality of energy cells 101, enclosed in a hermetically sealed cell box 102. Battery pack system 100 may be “maintenance-free” in the respect that it may be installed in a use location and does not have to be maintained by a maintenance technician during typical use.

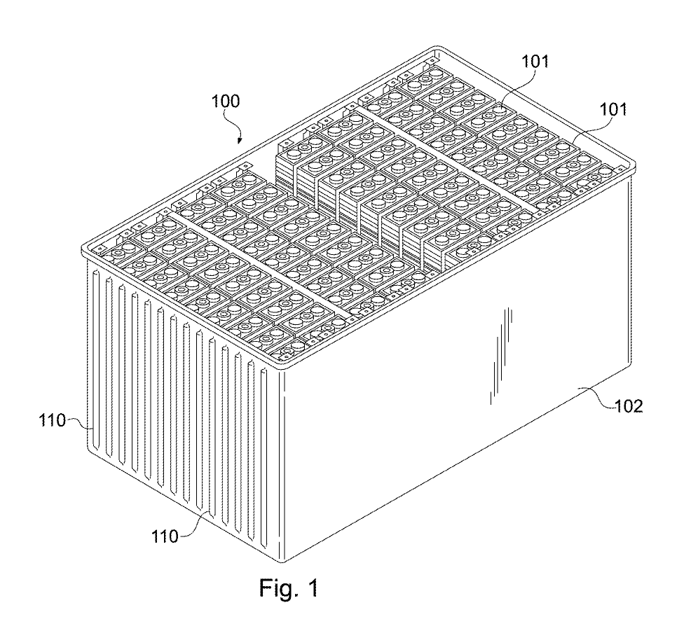

In an exemplary embodiment, and as illustrated in FIG. 1, the at least one energy cell 101 may comprise an array of x modules of y energy cells 101, where x equals 15 modules and y equals 8 energy cells 101 per module. In an alternative embodiment, 154 energy cells 101 may be used in battery pack system 100 in an array of 14 modules of 11 energy cells 101. Battery pack system 100 is rated at 48 kW, 380 to 560 volts, and 48 kilowatt-hours. System 100 is designed to have high thermal capacity and power density and to maintain system 100 within a desired temperature range, such as, for example, within a few degrees of ambient temperature.

Energy cells 101 are arranged in cell box 102 so as to provide maximum possible density of energy cells 101 (i.e. the least possible void space between adjacent energy cells 101) within cell box 102. Energy cells 101 may be rechargeable lithium ion batteries or other suitable energy cells. Energy cells 101 may be electrically coupled to each other in parallel, in series, or in a combination of series and parallel to meet the needs for which battery pack system 100 is intended to be used. Energy cells 101 may absorb and store energy from an application and then return the energy to the application at a later time. Alternatively, energy cells 101 may absorb energy from a main power source for an application and provide backup energy to the application in the event that the main power source is cut from the application, such as, for example, during a blackout.

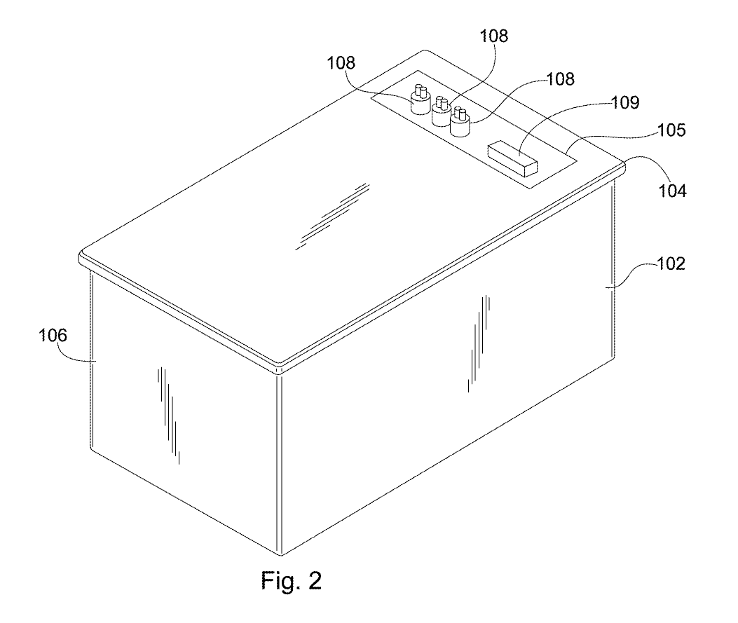

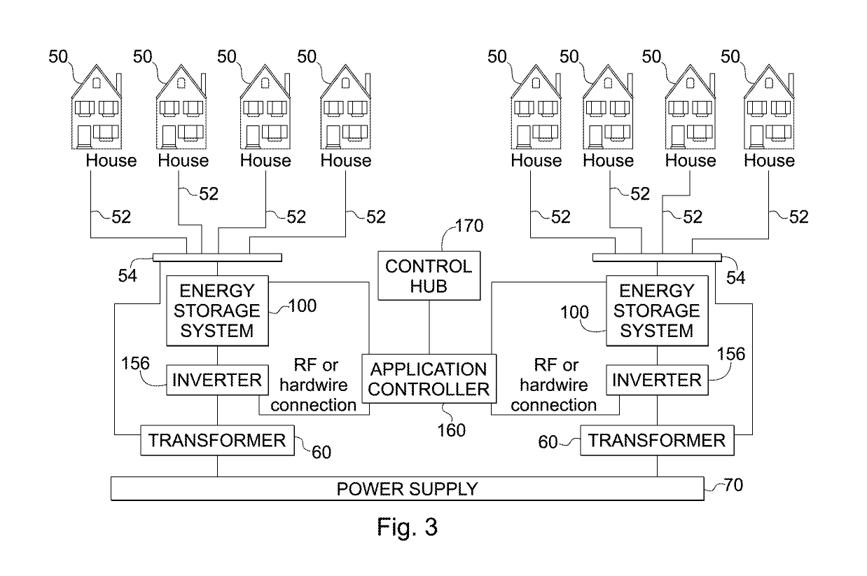

Referring to FIG. 2, cell box 102 has a cover 104 and a plurality of sides 106. Cover 104 has a bulk feedthrough connector 105 through which plurality of connection points 108 extending outwardly therefrom. Connection points 108 are used to electrically couple battery pack system 100 to a bi-directional power inverter 156 and an external device that uses electrical energy stored by energy cells 101, such as, for example, a house 50, illustrated in FIG. 3. Inverter 156 may be a 25 kilowatt inverter that converts direct current stored by energy cells 101 to alternating current, such as for household use. Additionally, referring back to FIG. 2, a connection point 109 extends outwardly from cover 104 and may be used to electrically couple battery pack system 100 to a control system 160 (illustrated in FIG. 3). External power connection points 108 and 109 are sealed with respect to cover 104 to maintain the integrity of cell box 102. External power connection points 108 and 109 enable cell box 102 to be tested and exchanged as a unit without disassembly.

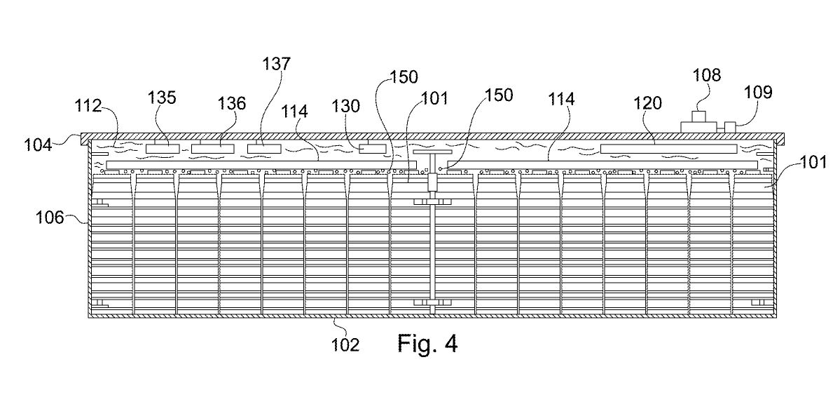

Referring back to FIG. 1, a plurality of fins 110 may be located along external surfaces of sides 106 of cell box 102. Fins 110 act as heat sinks to passively increase thermal exchange between cell box 102 and the exterior of cell box 102. Additionally, as shown in FIG. 4, a dielectric fluid, such as, for example, a mineral, non-conductive oil 112 fills cell box 102 and covers energy cells 101. Oil 112 is used to passively increase thermal exchange between energy cells 101 and cell box 102. In an exemplary embodiment, oil 112 may be a non-toxic biodegradable oil, such as, for example FR3-E200 from Copper Industries of Houston, Tex.

A phase-change material 150 is located in oil 112 inside cell box 102 and is used to fill the gap between energy cells 101 and the walls of cell box 102. Phase-change material 150 may be inserted into cell box 102 prior to adding oil 112, and oil 112 is then poured into cell box 102 in an amount sufficient to cover energy cells 101.

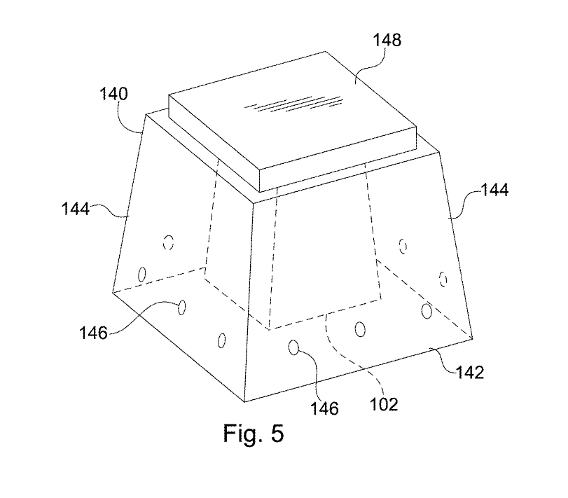

In an exemplary embodiment, phase-change material 150 may be a material such as paraffin. Phase-change material 150 may also be a plurality of separate elements, such as, for example, individual pellets. Phase-change material 150 is able to absorb a significant amount of heat energy from energy cells 101 and oil 112 without increasing temperature or changing to a liquid phase. A sufficient amount of phase-change material 150 is located within cell box 102 to maintain the temperature of cell box 102 within a few degrees, such as, for example, about twenty (20) degrees Celsius of an ambient temperature exterior to a containment box 140, shown in FIG. 5, in which cell box 102 is located. Desirably, the temperature of cell box 102 is maintained within about ten (10) degrees Celsius of the ambient temperature exterior to containment box 140. More desirably, the temperature of cell box 102 is maintained within about five (5) degrees Celsius of the ambient temperature exterior to containment box 140.

Optionally, a heater 114 may be located within cell box 102. Heater 114 may be used to regulate the temperature of cell box 102. For example, in cold climates, heater 114 may be used to heat energy cells 101. Heater 114 may be electrically coupled to at least one of energy cells 101 to provide electrical power to operate heater 114. Alternatively, heater 114 may be electrically coupled to an outside source, such as, for example, the device or application being powered by battery pack system 100. Heater 114 may be located on top of energy cells 101, as is illustrated in FIG. 4. Alternatively, or in addition, heater 114 may be located beneath energy cells 101.

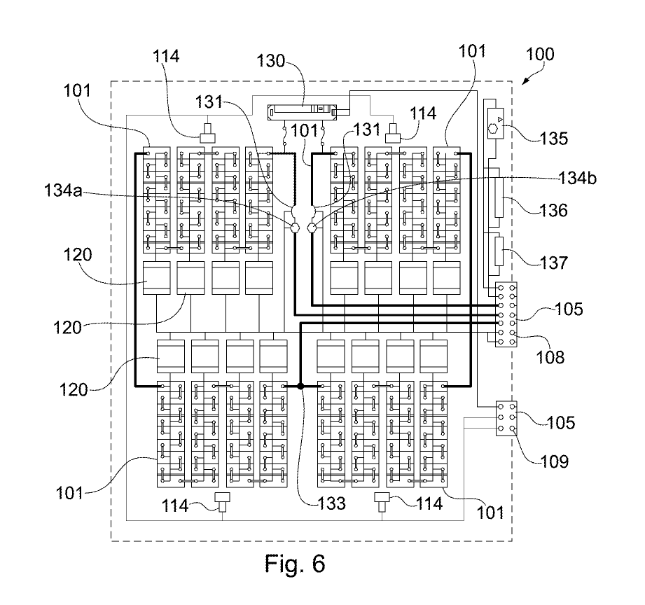

Referring to FIGS. 4 and 6, a battery management system 120 may be electrically coupled to each of energy cells 101. Battery management system 120 is used to-monitor the state of battery pack system 100. In an embodiment with a plurality of energy cells 101, battery management system 120 may monitor each of the plurality of energy cells 101, and may redistribute power from an energy cell 101 having more charge to another energy cell 101 having less charge, maintaining the energy cells within a cell voltage range less than 150 millivolts (mVolts), and most preferably within about 25 mVolts. An exemplary system for such redistribution is disclosed in U.S. patent application Ser. No. 12/262,672, which is owned by the Assignee of the present invention, and which is fully incorporated herein by reference.

An auxiliary power supply 130 is electrically coupled to energy cells 101 to receive power from energy cells 101. Auxiliary power supply 130 is also electrically coupled to ancillary controls and communications to provide power to these devices when power is not available from the main power source. Isolation contactors 131 isolate energy cells 101 from the output terminals of battery pack system 100 for shipping and other functions, such as, for example isolation of battery pack system 100 when required by the particular application for which battery pack system 100 is being used or in the case battery pack system 100 encounters an unsafe condition. Current sensors 134a, 134b monitor the electrical current on either side of battery pack system 100 to aid in the determination of the state of charge of battery pack system 100. A conductivity sensor 135 is immersed in oil 112 to monitor the conductivity of oil 112 and a temperature sensor 136 is also immersed in oil 112 to monitor the temperature of oil 112. A fluid level sensor 137 monitors the level of oil 112 in cell box 102. Output connections from conductivity sensor 135, temperature sensor 136, and level sensor 137 extend through bulk feedthrough connector 105 for connection to control system 160.

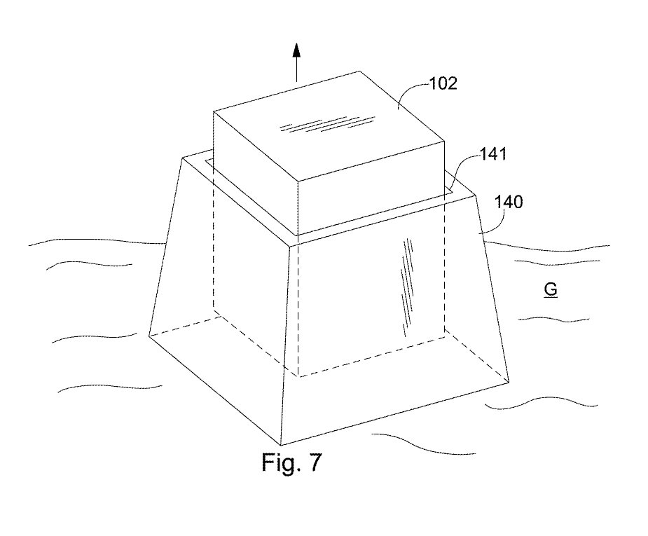

Referring now to FIGS. 5 and 7, containment box 140 has an open top 141 (shown in FIG. 7) and a bottom 142 on which cell box 102 rests. Containment box 140 also has a plurality of sides 144 located around a perimeter of bottom 142. The perimeter of containment box 140 is larger than that of cell box 102 and cell box 102 is located within containment box 140 such that a space is present between sides 106 of cell box 102 and sides 144 of containment box 140. In an exemplary embodiment, at least about 2 inches (about 5 cm) is present between sides 106 of cell box 102 and sides 144 of containment box 140.

Containment box 140 also includes a compartment 148 located above cell box 102 in which an inverter 156 (shown schematically in FIG. 3) may be located. Additionally, other devices (not shown), such as for example, battery management system 120 may optionally be located inside compartment 148.

Optionally, sides 144 each may include a plurality of openings 146 extending therethrough. Openings 146 provide fluid communication between cell box 102 and an exterior of containment box 140. Openings 146 provide a flow path for hot air to move upwards through containment box 140 if the temperature around sealed cell box 102 is higher than the ambient temperature to passively maintain a temperature of cell box 102. A small draft flow of ambient air through openings 146 is sufficient to dissipate heat that is generated during operation of battery pack system 100.

Optionally, containment box 140 may be comprised of plastic or other suitable insulating material and may be painted a white or with a reflective coating to prevent excessive heating of the sealed cell box 102.

In operation, as illustrated in an exemplary embodiment in FIG. 3, battery pack system 100 may be located exterior to a plurality of houses 50 and may provide electrical power to the plurality of houses 50 via inverter 156, which converts DC power from battery pack system 100 into AC power. The converted power is then transmitted to a power supply bus 54 to supply AC power to houses 50 via power cables 52. Battery pack system 100 is also electrically coupled via inverter 156 to a transformer 60 that is in turn electrically coupled to a high voltage alternating electrical current supply 70. Transformer 60 may be rated at 50 kilovolt-amps and 240/120 volts (alternating current). AC power from transformer 60 is transmitted to inverter 156, where the AC power is converted to DC power for storage by battery management system 100. Transformer 60 is also electrically coupled to power supply bus 54 to provide AC power to houses 50 when battery pack system 100 is not providing electrical power to houses 50.

Battery pack system 100 has a sleep mode wherein battery pack system 100 is electrically uncoupled from the device(s) that battery pack system 100 powers, as well as from battery management system 120. Battery management system 120 cycles between sleep mode and a monitoring mode such that, at predetermined intervals, battery management system 120 wakes up and monitors the state of health of battery pack system 100 and reports the state to an application controller 160. If the voltage of battery pack system 100 drops below a predetermined voltage value, battery pack system 100 is taken out of operation and transmits a signal to application controller 160 asking for conditioning. Once main power is restored to battery pack system 100 or application controller 160 decides to condition battery pack system 100, application controller 160 transmits a signal to the application to bring battery pack system 100 within the limits of allowable operating conditions. The application can be remotely controlled by a control hub 170 that has the capability to manage the application. The awakening of battery pack system 100 from a sleep mode is done by command of control hub 170. Upon command from control hub 170, application controller 160 provides control power to battery management system 120. Battery management system 120 does a self check and once it determines to be safe, battery pack system 100 allows the application to recharge battery pack system 100. When battery pack system 100 is within operating conditions, battery pack system 100 is placed in operation.

In an installed state, it may be desirable to remove battery pack system 100 without movement or exposure of the high voltage connections and cables. To that the preferred installation method will comprise some arrangement where the battery can be detached from the application without movement of the high voltage cables such that those coupled to transformer 60 or power supply bus 54. The installation shown in FIG. 7 includes containment box 140 which may be completely or partially buried below a ground level “G”. In a buried configuration, openings 146 in side walls 144 (shown in FIG. 5) may be omitted.

In the event that energy cells 101 need to be replaced, power cables 52 (shown in FIG. 3) that couple device 100 to homes 50 are disconnected from device 100. Compartment 148 with inverter 156 is next removed from containment box 140 through opening 141, as shown in FIG. 7, allowing cell box 102 to be lifted from containment box 140 through opening 141 in top of containment box 140, providing access to energy cells 101. Energy cells 101 may be removed from cell box 102 as necessary and replacement energy cells 101 may be installed in cell box 102. Alternatively, the entire cell box 102 may be replaced.

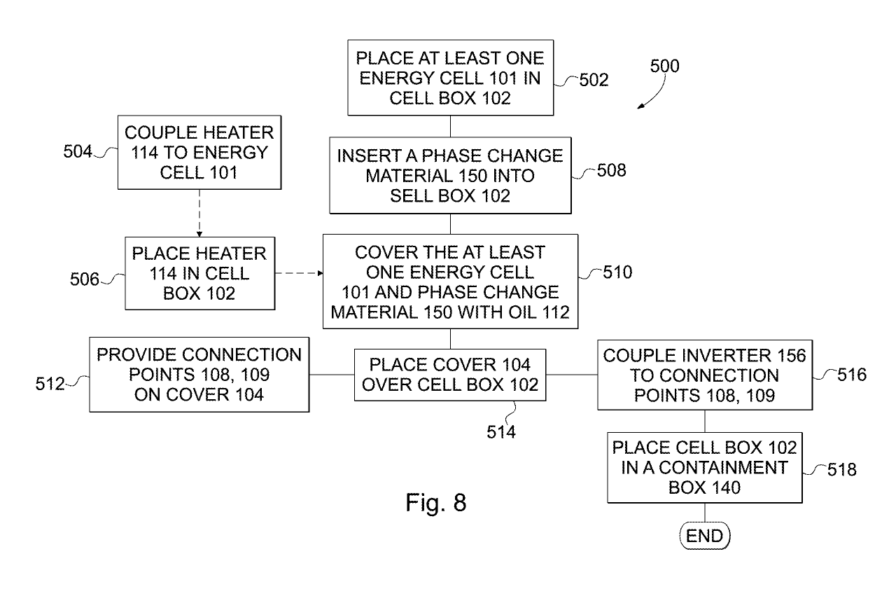

An exemplary embodiment of a manufacturing process for battery pack system 100 is now described and illustrated in flowchart 500 in FIG. 8. Step 502 includes placing at least one energy cell 101 in cell box 102. If heater 114 is used, step 504 includes the step of electrically coupling heater 114 to at least one energy cell 101 and step 506 includes placing heater 114 inside cell box 102. Step 508 includes inserting phase-change material 150 into cell box 102 and step 510 includes covering energy cells 101 in non-conductive oil 112.

Step 512 includes providing power connection points 108, 109 to cover 104 and step 514 includes placing cover 104 over cell box 102. Step 516 includes coupling inverter 156 to power connection points 108 on cover 104. Step 518 includes placing cell box 102 in containment box 140, forming a space between cell box 102 and containment box 140.

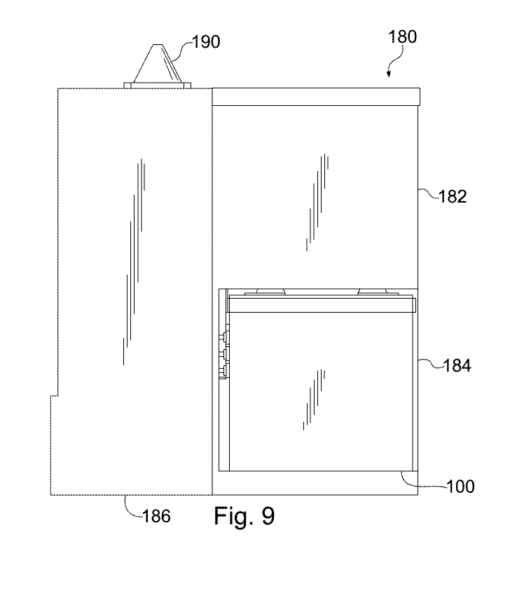

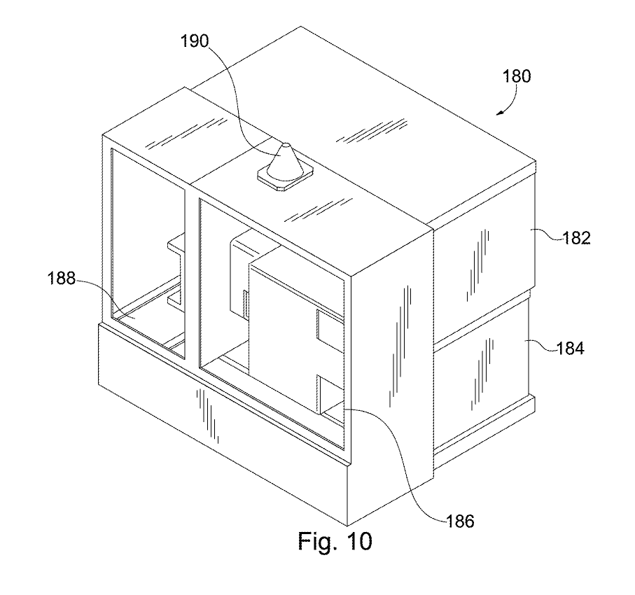

FIGS. 9 and 10 illustrate an alternate embodiment of the present invention. In this embodiment, an energy storage system 180 includes a pad mounted distribution transformer, located in a transformer compartment 182. Battery pack system 100 may be located in a battery pack compartment 184 located underneath transformer compartment 182. The cover to battery pack compartment 184 has been removed to illustrate an exemplary configuration of battery pack system 100 within battery pack compartment 182.

Related high voltage and low voltage components, including power inverters, as well as system control components, are located in adjacent compartments 186, 188, with high voltage components located in compartment 186 and low voltage components located in compartment 188. FIG. 10 shows covers to compartments 186, 188 removed. Optionally, a transmitter 190 may be located on top of energy storage system 180 to provide radio frequency communication with control hub 170 (shown in FIG. 3).

While the principles of the invention have been described above in connection with preferred embodiments, it is to be clearly understood that this description is made only by way of example and not as a limitation of the scope of the invention.

What is claimed is:

1. A thermal management battery pack system comprising:
a containment box having a plurality of sides located around a perimeter of the bottom;
a hermetically sealed cell box containing at least one energy cell located within the cell box, the cell box having a cover and a plurality of sides, the sides of the cell box being located away from the sides of the containment box;
a plurality of external power connection points located on the cover of the cell box;
a dielectric fluid filling the cell box around the at least one energy cell; and
a sufficient amount of a phase-change material located in the dielectric fluid to maintain a temperature within the cell box to within about five degrees Celsius of a temperature exterior to the containment box.

2. The thermal management battery pack system according to claim 1, wherein the phase-change material comprises a plurality of separate elements.

3. The thermal management battery pack system according to claim 1, further comprising an inverter located within the cell box and releasably coupled to the external power connections.

4. The thermal management battery pack system according to claim 1, further comprising a plurality of openings extending through the plurality of sides of the containment box, the openings providing fluid communication between the cell box and an exterior of the containment box.

5. The thermal management battery pack system according to claim 1, further comprising a heater located within the cell box.

6. The thermal management battery pack system according to claim 5, wherein the heater is electrically coupled to at least one of the energy cells.

7. The thermal management battery pack system according to claim 5, wherein the heater is electrically coupled to an outside source.

8. The thermal management battery pack system according to claim 1, further comprising a battery management system electrically coupled to the at least one energy cell.

9. The thermal management battery pack system according to claim 8, wherein the battery management system is adapted to cycle between a sleep mode and a monitoring mode.

10. A thermal management battery pack system comprising:
a cell box;
a plurality of energy cells located within the cell box; and
a thermal management system comprising:
a phase-change material located in the cell box; and
a dielectric fluid covering the plurality of energy cells and the phase-change material,
wherein an adequate type and amount of phase-change material is located in the cell box to maintain a temperature of the cell box within about twenty degrees Celsius of a temperature outside of the cell box.

11. The thermal management battery pack system according to claim 10, further comprising a heater located in the dielectric fluid and electrically coupled to one of the plurality of energy cells.

12. The thermal management battery pack system according to claim 10, further comprising a battery management system located in the dielectric fluid.

13. The thermal management battery pack system according to claim 10, wherein an adequate type and amount of phase-change material is located in the cell box to maintain a temperature of the cell box within about ten degrees Celsius of a temperature outside of the cell box.

14. A method of manufacturing a battery pack system comprising the steps of:
(a) placing at least one energy cell in a cell box;
(b) placing a phase-change material in the cell box;
(c) covering the at least one energy cell and the phase-change material in a dielectric fluid;
(d) placing a cover over the cell box; and
(e) placing the cell box in a containment box having a plurality of side walls, forming a space between the cell box and the side walls of the containment box.

15. The method according to claim 14, further comprising the step of electrically coupling a heater to the at least one energy cell and placing the heater inside the dielectric fluid.

16. The method according to claim 14, further comprising the step of providing power connection points to the cover.

17. The method according to claim 16, further comprising the step of coupling an inverter to the power connection points on the cover.

18. A battery pack system manufactured according to the steps of claim 14.
